(19) United States
(12) Patent Application Publication
(10) Pub. No.: US 2024/0249176 A1
(43) Pub. Date: Jul. 25, 2024

(54) PERFORMING BANG-ANNEAL-BANG QUANTUM OPTIMIZATION

(71) Applicant: Government of the United States of America, as represented by the Secretary of Commerce, Gaithersburg, MD (US)

(72) Inventors: Lucas Tyler Brady, Greenbelt, MD (US); Alexey Vyacheslavovich Gorshkov, Rockville, MD (US); Christopher Lee Baldwin, Hyattsville, MD (US); Aniruddha Bapat, College Park, MD (US); Yaroslav Kharkov, Washington, DC (US); Przemyslaw Dariusz Bienias, Silver Spring, MD (US); Lucas Kocia, Oakland, CA (US)

(21) Appl. No.: 18/560,591

(22) PCT Filed: May 12, 2022
(86) PCT No.: PCT/US2022/029038

§ 371 Date: Nov. 13, 2023

Related U.S. Application Data
(60) Provisional application No. 63/187,507, filed on May 12, 2021.

(51) Int. Cl. G06N 10/60; G06N 10/40

(52) U.S. Cl. CPC G06N 10/60; G06N 10/40

(57) ABSTRACT

A process for bang-anneal-bang quantum optimization includes: identifying base curve v(t); setting a total runtime of the process; creating an initial guess for parameters in an ansatz; creating an initial guess for parameters in an ansatz; evolving a quantum state from a ground state of B following Hamiltonian H(t)=u(t) B+(1−u(t)) C and, at termination of evolving the quantum state, measuring the resulting quantum state; updating the parameters for the ansatz based on the resulting quantum state; repetitively creating the ansatz for u(t), evolving the quantum state from the ground state of B following Hamiltonian H(t), and, at termination of evolving the quantum state, determining the resulting quantum state until the classical outer loop converges to a selected convergence limit; and returning the final form of u(t) to perform bang-anneal-bang quantum optimization.

### CROSS REFERENCE TO RELATED APPLICATIONS

This application claims the benefit of U.S. Provisional Patent Application Ser. No. 63/187,507 (filed May 12, 2021), which is herein incorporated by reference in its entirety.

### STATEMENT REGARDING FEDERALLY SPONSORED RESEARCH

This invention was made with United States Government support from the National Institute of Standards and Technology (NIST), an agency of the United States Department of Commerce. The Government has certain rights in this invention.

### BRIEF DESCRIPTION

Disclosed is a computer-implemented process for performing bang-anneal-bang quantum optimization, the process comprising: identifying base curve v(t); setting a total runtime of the process; creating an initial guess for parameters in an ansatz; creating an initial guess for parameters in an ansatz; evolving a quantum state from a ground state of B following Hamiltonian H(t)=u(t) B+(1−u(t)) C and, at termination of evolving the quantum state, measuring the resulting quantum state; updating the parameters for the ansatz based on the resulting quantum state; repetitively creating the ansatz for u(t), evolving the quantum state from the ground state of B following Hamiltonian H(t), and, at termination of evolving the quantum state, determining the resulting quantum state until the classical outer loop converges to a selected convergence limit; and returning the final form of u(t) to perform bang-anneal-bang quantum optimization.

Disclosed is a method implemented by a system of one or more processors, the method comprising: identifying base curve v(t); setting a total runtime of the process; creating an initial guess for parameters in an ansatz; creating an initial guess for parameters in an ansatz; evolving a quantum state from a ground state of B following Hamiltonian H(t)=u(t) B+(1−u(t)) C and, at termination of evolving the quantum state, measuring the resulting quantum state; updating the parameters for the ansatz based on the resulting quantum state; repetitively creating the ansatz for u(t), evolving the quantum state from the ground state of B following Hamiltonian H(t), and, at termination of evolving the quantum state, determining the resulting quantum state until the classical outer loop converges to a selected convergence limit; and returning the final form of u(t) to perform bang-anneal-bang quantum optimization.

Disclosed is a non-transitory computer storage media storing instructions for execution by a system of one or more processors, the system being included with instructions causing the one or more processors to perform operations comprising: identifying base curve v(t); setting a total runtime of the process; creating an initial guess for parameters in an ansatz; creating an initial guess for parameters in an ansatz; evolving a quantum state from a ground state of B following Hamiltonian H(t)=u(t) B+(1−u(t)) C and, at termination of evolving the quantum state, measuring the resulting quantum state; updating the parameters for the ansatz based on the resulting quantum state; repetitively creating the ansatz for u(t), evolving the quantum state from the ground state of B following Hamiltonian H(t), and, at termination of evolving the quantum state, determining the resulting quantum state until the classical outer loop converges to a selected convergence limit; and returning the final form of u(t) to perform bang-anneal-bang quantum optimization.

### BRIEF DESCRIPTION OF THE DRAWINGS

The following description cannot be considered limiting in any way. Various objectives, features, and advantages of the disclosed subject matter can be more fully appreciated with reference to the following detailed description of the disclosed subject matter when considered in connection with the following drawings, in which like reference numerals identify like elements.

FIG. 1 shows steps in performing bang-anneal-bang quantum optimization, according to some embodiments.

FIG. 2 shows a construction and result from making an ansatz for u(t) conditioned upon time relative to T, \tilde{γ}, and \tilde{β}, according to some embodiments.

FIG. 3 shows pseudo-code for performing bang-anneal-bang quantum optimization, according to some embodiments.

FIG. 4 shows a block diagram of an example, non-limiting operating environment in which one or more embodiments described herein can be facilitated.

### DETAILED DESCRIPTION

A detailed description of one or more embodiments is presented herein by way of exemplification and not limitation.

Quantum annealing and quantum approximate optimization algorithm (QAOA), quantum adiabatic optimization, and variational quantum eigensolver are algorithms for solving classical or quantum optimization problems to find the ground state of a Hamiltonian Ĉ. A second Hamiltonian, \hat{B}, is introduced, and the system is initialized in the ground state of \hat{B}. The system is then evolved under the time-dependent Hamiltonian

$$\hat{H} ( i ) = u ( t ) \hat{B} + ( 1 - u ( t ) ) \hat{C} .$$

QAOA is parameterized in terms of the lengths of its bangs, with the angles βᵢ determining the length of \hat{B} bangs and γi determining the lengths of the Ĉ bangs for i=1, 2, . . . , p. As p increases, these angles start to fall on a curve provided by the following well-defined function

$$v ( \frac{i - 1}{p - 1} ) = \frac{{β}_{i}}{{β}_{i} + {γ}_{i}}$$

that holds in the limit of moderate to large p. Furthermore, this smooth monotonically decreasing curve obeys the properties to serve as a quantum annealing schedule, as it holds in the limit of moderate to large p.

Here, v(t) is the broad structure of the annealing region. Some features are not captured by this interpretation. The optimal curve includes bangs at the beginning and end, which serve the purpose of exciting the system partially out of the ground state (and de-exciting it back to the ground state) to allow for potential non-ground state evolution. Further, the optimal annealing region has an oscillatory structure. The period of oscillations matches with the length of a pair of bangs in QAOA so QAOA does not see this additional structure.

The optimization apparatus and process for performing bang-anneal-bang quantum optimization described herein can include a hybrid algorithm that overcomes these technical deficiencies of conventional technology and takes such features into account by making and optimizing an ansatz that captures the features of the optimal protocol. It is contemplated that the optimal protocol may be findable, but finding it may be impractical or unscalable. The optimization apparatus and process for performing bang-anneal-bang quantum optimization described herein involves a few variational parameters and is more feasible to implement than conventional ways.

It should be appreciated that analog quantum algorithms such as quantum annealing and the quantum approximate optimization algorithm (QAOA) have the power of quantum computing/advantage and can involve classical optimization and tuning to use their full power. Tuning can be costly and undirected, lacking information about the problem instance. The optimization apparatus and performing bang-anneal-bang quantum optimization described herein overcome these problems and provide a more efficient way to tune a quantum annealing-like algorithm without requiring too many parameters and provide better results than conventional parameterizations such as QAOA.

It has been discovered that an optimization apparatus and performing bang-anneal-bang quantum optimization described herein provide a classical method for optimizing a quantum annealing algorithm so that it can produce a better solution in shorter time. Under this guise, and referring again to the above Hamiltonian, such can work on a system with Hamiltonian Ĥ(t)=u(t)\hat{B}+(1−u(t))Ĉ or a similarly defined annealing schedule. Hamiltonian \hat{B} can be a mixer Hamiltonian, and Hamiltonian Ĉ can be a problem Hamiltonian. The initial state of the quantum system is the ground state of \hat{B}, and the target state is the ground state of Ĉ.

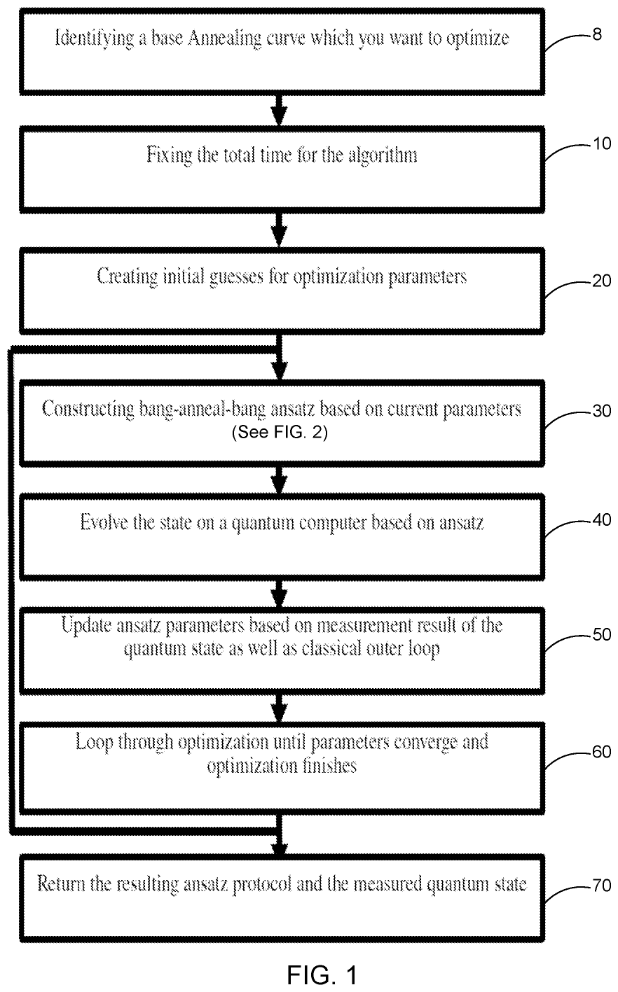

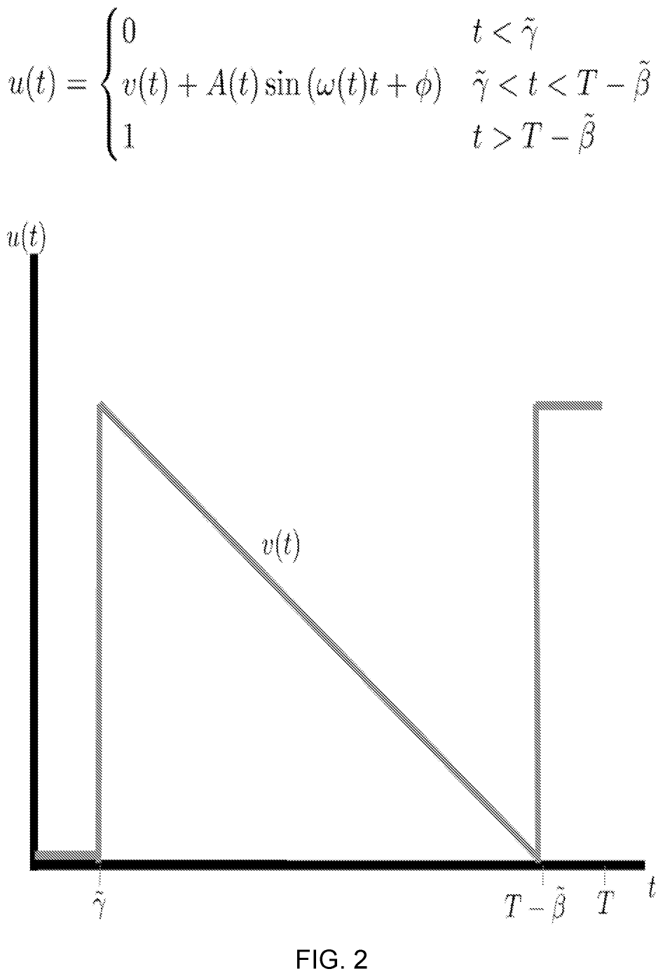

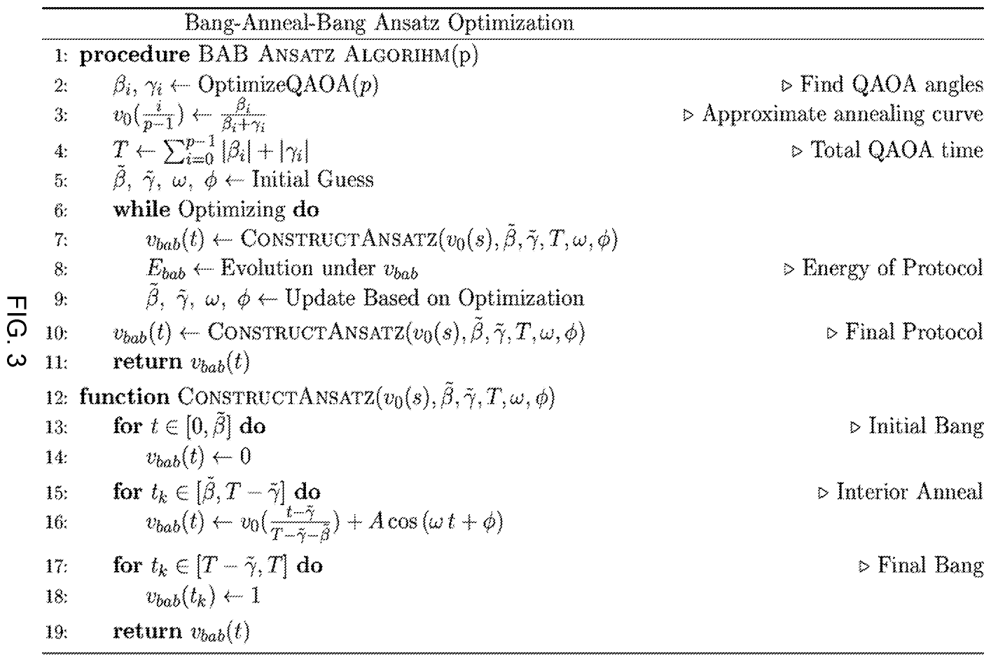

In an embodiment, with reference to FIG. 1, FIG. 2, and FIG. 3, a process for performing bang-anneal-bang quantum optimization includes: identifying base curve v(t) (step 8); setting a total runtime of the process (step 10); creating an initial guess for parameters in an ansatz (step 20); creating an initial guess for parameters in an ansatz (step 30); evolving a quantum state from a ground state of B following Hamiltonian H(t)=u(t) B+(1−u(t)) C and, at termination of evolving the quantum state, measuring the resulting quantum state (step 40); updating the parameters for the ansatz based on the resulting quantum state (step 50); repetitively creating the ansatz for u(t), evolving the quantum state from the ground state of B following Hamiltonian H(t), and, at termination of evolving the quantum state, determining the resulting quantum state until the classical outer loop converges to a selected convergence limit (step 60); and returning the final form of u(t) (step 70) to perform bang-anneal-bang quantum optimization.

In an embodiment, the process also includes taking v(t) as a linear function such that v(t)=1−t/T0. Here, T0 is an amount of time under which the quantum computer can maintain coherence.

In an embodiment, the process also includes determining v(t) by performing a QAOA procedure at some desired depth p. In this case, if the parameters for the mixer Hamiltonian are beta_i, and the parameters for the problem Hamiltonian are gamma_i, v(t) is an interpolation of the discrete function defined by v((i−1)/(p−1))=beta_i/(beta_i+gamma_i). For this, runtime T0 can be set to be the time of the QAOA procedure or can be extended.

In an embodiment, the process also can include, if the process is initialized based on QAOA, setting beta=beta_p and gamma=gamma_0 from the QAOA procedure. The process also can include, making omega=2π/tau, wherein tau is the average time taken in each beta-gamma layer of QAOA.

In an embodiment, the process also can include parameterizing omega and A. If initializing this process based on QAOA, these can be parameterized into functions that are constants binned into p regions.

In an embodiment, the process also can include using T as a variational parameter.

In an embodiment, the process also can include updating and optimization by a classical optimization algorithm, e.g., Nelder-Mead or gradient descent. It is contemplated that the choice of classical optimization algorithm determine what measurements are made in step 40.

In identifying base curve v(t), base curve v(t) can include preexisting knowledge about the quantum algorithm and problem. In creating an initial guess for parameters in an ansatz, the parameters for the ansatz can include beta>0, gamma>0, omega>0, A>0, an phi\in[0,2pi). In creating an initial guess for parameters in an ansatz, u(t) can start with a u(t)=0 region of length gamma and end with a u(t)=1 region of length beta. The entirety of the function u(t)=v(t)+c(t) can be inserted between these bounds, wherein c(t)=A sin(omega t+phi). In updating the parameters for the ansatz, updating optimizes the parameters to minimize the expectation value <C> with respect to the final state. In step 60, a sufficient convergence limit can be selected based on the type of problem and desired runtime. In returning the final form of u(t), the resulting quantum state or a desired measurement/expectation value also can be returned.

In an embodiment, a process for performing bang-anneal-bang quantum optimization includes: performing a normal QAOA procedure for large enough p to be able to identify the shape of

$$v ( \frac{i - 1}{{p}^{- 1}} ) ,$$

e.g., for p=5, 10, 20, and the like or a suitable p; interpreting the QAOA curve

$$v ( \frac{i - 1}{{p}^{- 1}} )$$

as a smooth annealing region; making an ansatz for the bang-anneal-bang curve that comprises one u=0 bang at the beginning, the annealing curve, defined by

$$v ( \frac{i - 1}{{p}^{- 1}} )$$

in the middle, and one u=1 bang at the end; superposing an oscillatory curve c(t)=A(t) sin(ω(t)t+q) onto the annealing region so that the annealing region is fit by v(t)+c(t); using the ansatz to run a variational algorithm and determining the optimal values of the selected variational parameters to optimize with respect to the final energy of the state with respect to C.

In the process, lengths of the initial bang γ̅ and final bang β̅ can be variational parameters. There are multiple ways to parameterize the interior anneal. The length of the anneal can be fixed to be the same as the time the QAOA procedure takes to complete minus the bang lengths, T_{QAOA}−γ̅−B̅. Optionally, the frequency of oscillations can be chosen to be ω(t)=2πp/T_{QAOA} and amplitude of the oscillations A(t)=A can be a variational parameter. Optionally, the frequency of oscillations ω(t)=ω and amplitude of oscillations A(t)=A can be static variational parameters. Optionally, the frequency of oscillations ω(t) can be a variable function so that the period of a given oscillation matches the length of the corresponding QAOA layer. The amplitudes of oscillation can be fixed to be the same or treated as separate variational parameters in each oscillation.

In some embodiments, the length of the anneal, T_{A}, can be treated as a variational parameter. The frequency can be taken as fixed ω(t)=2πp/T_{QAOA} or allowed to vary as a free fitted parameter. The amplitude of oscillation can be a single variational parameter or can be binned into different regions with the amplitude in each region being treated as a variational parameter. The process can include adjusting this ansatz for the system under study, e.g., in consideration of how many variational parameters the specific setting is capable of handling.

The optimal φ can be 0, but for optimization this phase can be a variational parameter. The ansatz can have three (β⁻, γ⁻, and A), but can have more, variational parameters.

Performing bang-anneal-bang quantum optimization produces a better protocol than interpreting u=v and gives an improvement over results from the QAOA protocol used in the initial step. It is contemplated that the QAOA protocol at the beginning of the process can be skipped if the optimal or an acceptable annealing curve is determined through other means.

Embodiments for performing bang-anneal-bang quantum optimization are intended to efficiently use scarce resources. It should be appreciated that quantum computing resources are rare. Access to quantum computing resources may be expensive or such quantum computing resources may be inaccessible given geographic limitations. Even though a user may have direct access to a quantum computer, the user may be required to possess sophisticated expertise to configure the quantum computer and/or choose an adequate quantum algorithm for solving a computational task; otherwise, the user does not gain the benefit from the speedy computations offered by the quantum computer. Even a superior quantum computer may not exhibit any advantage over classical computing resources in solving a problem if the right algorithm, the right problem, and the right parameters are not chosen. On the other hand, from a user's perspective, a computational problem may be a very large computational task involving many smaller sub-tasks. Each of these sub-tasks may possess a different complexity characteristic. Therefore, using the right computing resource, the right algorithm, and the right parameter may be essential to solve the original problem efficiently and/or benefit from the potential quantum speedup.

Embodiments for performing bang-anneal-bang quantum optimization provide quantum-ready services or quantum-enabled services. Quantum-ready services may advantageously make it easier for a user to manage quantum resources and switch between a classical or quantum computation resource. Additionally, a quantum-enabled framework may allow users to use both classical and quantum resources in a hybrid manner such that the framework intelligently chooses the right solver and the right parameters for each particular sub-problem or subtask.

Embodiments for performing bang-anneal-bang quantum optimization facilitate quantum computing and optimization of various problems. In some embodiments, systems, media, networks, and methods include a quantum computer, or use of the same. Quantum computation uses quantum bits (qubits), which can be in superpositions of states. A quantum Turing machine is a theoretical model of such a computer, and is also known as a universal quantum computer. Quantum computers share theoretical similarities with non-deterministic and probabilistic computers.

In some embodiments, a quantum computer comprises one or more quantum processors. A quantum computer may be configured to perform one or more quantum algorithms. A quantum computer may store or process data represented by quantum bits (qubits). A quantum computer may be able to solve certain problems much more quickly than any classical computers that use even the best currently available algorithms, like integer factorization using Shor's algorithm or the simulation of quantum many-body systems. There exist quantum algorithms, such as Simon's algorithm, that run faster than any possible probabilistic classical algorithm. Examples of quantum algorithms include, but are not limited to, quantum optimization algorithms, quantum Fourier transforms, amplitude amplifications, quantum walk algorithms, and quantum evolution algorithms. Quantum computers may be able to efficiently solve problems that no classical computer may be able to solve within a reasonable amount of time. Thus, a system disclosed herein utilizes the merits of quantum computing resources to solve complex problems.

Any type of quantum computers may be suitable for the technologies disclosed herein. Examples of quantum computers include, but are not limited to, adiabatic quantum computers, quantum gate arrays, one-way quantum computer, topological quantum computers, quantum Turing machines, superconductor-based quantum computers, trapped ion quantum computers, optical lattices, quantum dot computers, spin-based quantum computers, spatial-based quantum computers, Loss-DiVincenzo quantum computers, nuclear magnetic resonance (NMR) based quantum computers, liquid-NMR quantum computers, solid state NMR Kane quantum computers, electrons-on-helium quantum computers, cavity-quantum-electrodynamics based quantum computers, molecular magnet quantum computers, fullerene-based quantum computers, linear optical quantum computers, diamond-based quantum computers, Bose-Einstein condensate-based quantum computers, transistor-based quantum computers, and rare-earth-metal-ion-doped inorganic crystal based quantum computers. A quantum computer may comprise one or more of: a quantum annealer, an Ising solver, an optical parametric oscillator (OPO), or a gate model of quantum computing.

A system of the present disclosure may include or employ quantum-ready or quantum-enabled computing systems. A quantum-ready computing system may comprise a digital computer operatively coupled to a quantum computer. The quantum computer may be configured to perform one or more quantum algorithms. A quantum-enabled computing system may comprise a quantum computer and a classical computer, the quantum computer and the classical computer operatively coupled to a digital computer. The quantum computer may be configured to perform one or more quantum algorithms for solving a computational problem. The classical computer may comprise at least one classical processor and computer memory, and may be configured to perform one or more classical algorithms for solving a computational problem.

The term quantum annealer and like terms generally refer to a system of superconducting qubits that carries optimization of a configuration of spins in an Ising spin model using quantum annealing, as described, for example, in Farhi, E. et al., “Quantum Adiabatic Evolution Algorithms versus Simulated Annealing” arXiv.org: quant ph/0201031 (2002), pp. 1-16. An embodiment of such an analog processor is disclosed by McGeoch, Catherine C. and Cong Wang, (2013), “Experimental Evaluation of an Adiabatic Quantum System for Combinatorial Optimization” Computing Frontiers,” May 14-16, 2013 (http://www.cs.amherst.edu/ccm/cf14-mcgeoch.pdf) and also disclosed in U.S. Patent Application Publication Number US 2006/0225165.

In some embodiments, a classical computer may be configured to perform one or more classical algorithms. A classical algorithm (or classical computational task) may be an algorithm (or computational task) that is able to be executed by one or more classical computers without the use of a quantum computer, a quantum-ready computing service, or a quantum-enabled computing service. A classical algorithm may be a non-quantum algorithm. A classical computer may be a computer which does not comprise a quantum computer, a quantum-ready computing service, or a quantum-enabled computer. A classical computer may process or store data represented by digital bits (e.g., zeroes (“0”) and ones (“1”)) rather than quantum bits (qubits). Examples of classical computers include, but are not limited to, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles.

In an aspect, the present disclosure provides a system for quantum-ready optimization. The computing system may comprise a digital computer operatively coupled to a remote quantum computer over a network. The quantum computer may be configured to perform one or more quantum algorithms. The digital computer may comprise at least one computer processor and computer memory. The computer memory may include a computer program with instructions executable by the at least one computer processor to render an application. The application may facilitate use of the quantum computer by a user.

In another aspect, the present disclosure provides a system for quantum-enabled optimization. The computing system may comprise a quantum computer and a classical computer, the quantum computer and the classical computer operatively coupled to a digital computer over a network. The quantum computer may be configured to perform one or more quantum algorithms for solving a computational problem. The classical computer may comprise at least one classical processor and computer memory, and may be configured to perform one or more classical algorithms for solving a computational problem. The digital computer may comprise at least one computer processor and computer memory, wherein the digital computer may include a computer program with instructions executable by the at least one computer processor to render an application. The application may facilitate use of the quantum computer and/or the classical computer by a user.

Some implementations may use quantum computers along with classical computers operating on bits, such as personal desktops, laptops, supercomputers, distributed computing, clusters, cloud-based computing resources, smartphones, or tablets.

The system may include a gateway programmed or configured to receive a request over the network. The request may comprise a computational task. Examples of a computational task include, but are not limited to, search, optimization, statistical analysis, modeling, data processing, etc. In some embodiments, a request may comprise a dataset; for example, a data matrix including variables and observations for creating a modeling or analyzing statistics of the data set. Further, a solution may be derived; for example, an optimal model underlying a given dataset is derived from a quantum computer; a statistical analysis is performed by a quantum computer.

The system may comprise a queuing unit programmed or configured to store and order the request in one or more queues. The system may comprise a cluster manager programmed or configured to create an instance/container (also “worker” herein) to (1) translate the request in the queue into one or more quantum machine instructions, (2) deliver the one or more quantum machine instructions to the quantum computer over the network to perform the computational task, and (3) receive one or more solutions from the quantum computer. The one or more solutions may be stored in a database of the system. The system may comprise a logging unit programmed or configured to log an event of the worker.

The system may comprise an interface for a user. In some embodiments, the interface may comprise an application programming interface (API). The interface may provide a programmatic model that abstracts away (e.g., by hiding from the user) the internal details (e.g., architecture and operations) of the quantum computer. In some embodiments, the interface may minimize a need to update the application programs in response to changing quantum hardware. In some embodiments, the interface may remain unchanged when the quantum computer has a change in internal structure.

### Quantum-Enabled and Quantum-Ready Computing

The present disclosure provides systems, media, networks, and methods that may include quantum-enabled computing or use of quantum-enabled computing. Quantum computers may be able to solve certain classes of computational tasks more efficiently than classical computers. However, quantum computation resources may be rare and expensive, and may involve a certain level of expertise to be used efficiently or effectively (e.g., cost-efficiently or cost-effectively). A number of parameters may be tuned in order for a quantum computer to deliver its potential computational power.

Quantum computers (or other types of non-classical computers) may be able to work alongside classical computers as co-processors. A hybrid architecture of quantum-enabled computation can be very efficient for addressing complex computational tasks, such as hard optimization problems. A system disclosed herein may provide a remote interface capable of solving computationally expensive problems by deciding if a problem may be solved efficiently on a quantum-ready or a classical computing service. The computing service behind the interface may be able to efficiently and intelligently decompose or break down the problem and delegate appropriate components of the computational task to a quantum-ready or a classical service.

### Computer Program

In some embodiments, the systems, media, networks and methods described herein include at least one computer program, or use of the same. A computer program includes a sequence of instructions, executable in the digital processing device's CPU, written to perform a specified task. Computer readable instructions may be implemented as program units, such as functions, objects, Application Programming Interfaces (APIs), data structures, and the like, that perform particular tasks or implement particular data types (e.g., abstract data types). In light of the disclosure provided herein, a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In some embodiments, a computer program includes one or more software units. In some embodiments, a computer program includes, in part or in whole, one or more web applications, one or more mobile applications, one or more standalone applications, one or more web browser plug-ins, extensions, add-ins, or add-ons, or combinations thereof.

### Software Modules

In some embodiments, the systems, media, networks and methods described herein include software, server, and/or database modules, or use of the same. Software modules may be created using various machines, software, and programming languages. The software modules disclosed herein are implemented in a multitude of ways. In some embodiments, a software module comprises a file, a section of code, a programming object, a programming structure, or combinations thereof. In some embodiments, a software module comprises a plurality of files, a plurality of sections of code, a plurality of programming objects, a plurality of programming structures, or combinations thereof. In some embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In some embodiments, software modules are hosted on cloud computing platforms. In some embodiments, software modules are hosted on one or more machines in one location. In other embodiments, software modules are hosted on one or more machines in more than one location.

It is contemplated that a potential first application of quantum computers may be classical optimization, e.g., finding approximate solutions to the traveling salesman problem and quantum optimization, e.g., finding ground states of molecules and materials. The bang-anneal-bang protocol described herein can solve such optimization problems on a quantum computer. The bang-anneal-bang protocol performs better by determining an optimum faster or gets closer to the optimum under a fixed time constraint than conventional protocols, including quantum annealing, QAOA, and VQE.

A computer program product facilitating solving an optimization problem can be provided, and the computer program product can comprise a computer readable storage medium having program instructions embodied therewith. The program instructions can be executable by a processor to cause the processor to obtain a starting Hamiltonian having associated starting control parameters, and use quantum hardware to deform the starting Hamiltonian into a deformed Hamiltonian associated with optimal control parameters for that deformed Hamiltonian. Other instructions can use the quantum hardware to repeatedly deform the deformed Hamiltonian with the associated optimal control parameters for that deformed Hamiltonian into further deformed Hamiltonians and further optimal control parameters associated therewith until a desired Hamiltonian is reached and output information corresponding to the desired Hamiltonian and the optimal control parameters associated with the desired Hamiltonian.

Other aspects can comprise instructions to sample based on the information corresponding to the desired Hamiltonian and the optimal control parameters associated with the desired Hamiltonian to obtain data that provide approximations to an optimization problem. Still other aspects can comprise instructions to generate a set of trial states by a physical time evolution of the quantum hardware interspersed with control pulses that generate entanglement, measuring a quantum cost function for the trial states and determining a trial state resulting in optimal values.

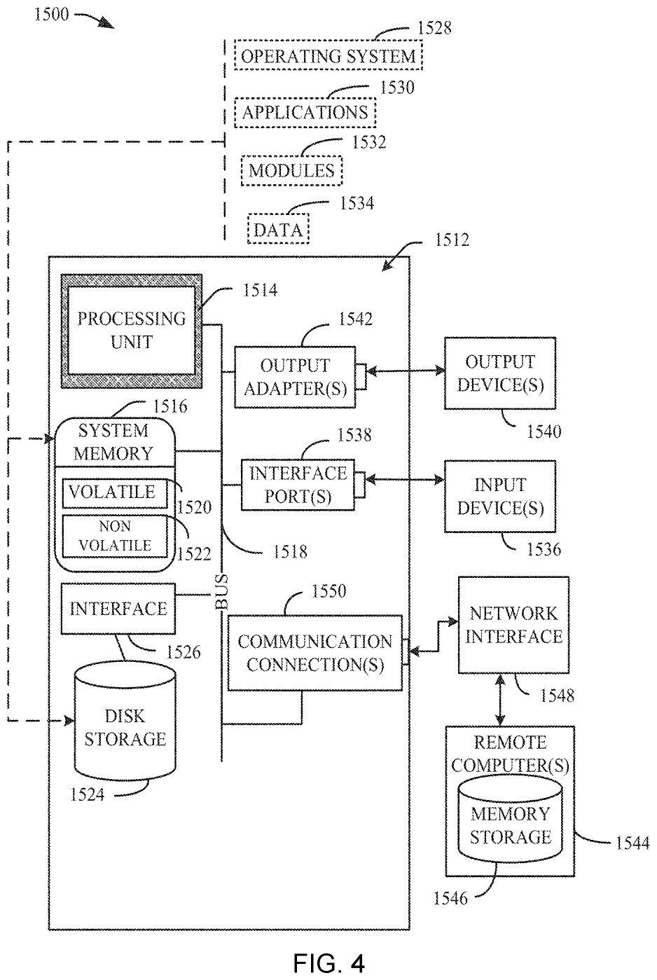

In order to provide a context for the various aspects of the disclosed subject matter, FIG. 4 as well as the following discussion are intended to provide a general description of a suitable environment in which the various aspects of the disclosed subject matter can be implemented. FIG. 15 illustrates a block diagram of an example, non-limiting operating environment in which one or more embodiments described herein can be facilitated. Repetitive description of like elements employed in other embodiments described herein is omitted for sake of brevity.

With reference to FIG. 4, a suitable operating environment 1500 for implementing various aspects of this disclosure can also include a computer 1512. The computer 1512 can also include a processing unit 1514, a system memory 1516, and a system bus 1518. The system bus 1518 couples system components including, but not limited to, the system memory 1516 to the processing unit 1514. The processing unit 1514 can be any of various available processors. Dual microprocessors and other multiprocessor architectures also can be employed as the processing unit 1514. The system bus 1518 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 1516 can also include volatile memory 1520 and nonvolatile memory 1522. The basic input/output system (BIOS), containing the basic routines to transfer information between elements within the computer 1512, such as during start-up, is stored in nonvolatile memory 1522. Computer 1512 can also include removable/non-removable, volatile/nonvolatile computer storage media. FIG. 15 illustrates, for example, a disk storage 1524. Disk storage 1524 can also include, but is not limited to, devices like a magnetic disk drive, floppy disk drive, tape drive, Jaz drive, Zip drive, LS-100 drive, flash memory card, or memory stick. The disk storage 1524 also can include storage media separately or in combination with other storage media. To facilitate connection of the disk storage 1524 to the system bus 1518, a removable or non-removable interface is typically used, such as interface 1526. FIG. 15 also depicts software that acts as an intermediary between users and the basic computer resources described in the suitable operating environment 1500. Such software can also include, for example, an operating system 1528. Operating system 1528, which can be stored on disk storage 1524, acts to control and allocate resources of the computer 1512.

System applications 1530 take advantage of the management of resources by operating system 1528 through program modules 1532 and program data 1534, e.g., stored either in system memory 1516 or on disk storage 1524. It is to be appreciated that this disclosure can be implemented with various operating systems or combinations of operating systems. A user enters commands or information into the computer 1512 through input device(s) 1536. Input devices 1536 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1514 through the system bus 1518 via interface port(s) 1538. Interface port(s) 1538 include, for example, a serial port, a parallel port, a game port, and a universal serial bus (USB). Output device(s) 1540 use some of the same type of ports as input device(s) 1536. Thus, for example, a USB port can be used to provide input to computer 1512, and to output information from computer 1512 to an output device 1540. Output adapter 1542 is provided to illustrate that there are some output devices 1540 like monitors, speakers, and printers, among other output devices 1540, which require special adapters. The output adapters 1542 include, by way of illustration and not limitation, video and sound cards that provide a means of connection between the output device 1540 and the system bus 1518. It should be noted that other devices and/or systems of devices provide both input and output capabilities such as remote computer(s) 1544.

Computer 1512 can operate in a networked environment using logical connections to one or more remote computers, such as remote computer(s) 1544. The remote computer(s) 1544 can be a computer, a server, a router, a network PC, a workstation, a microprocessor based appliance, a peer device or other common network node and the like, and typically can also include many or all of the elements described relative to computer 1512. For purposes of brevity, only a memory storage device 1546 is illustrated with remote computer(s) 1544. Remote computer(s) 1544 is logically connected to computer 1512 through a network interface 1548 and then physically connected via communication connection 1550. Network interface 1548 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1550 refers to the hardware/software employed to connect the network interface 1548 to the system bus 1518. While communication connection 1550 is shown for illustrative clarity inside computer 1512, it can also be external to computer 1512. The hardware/software for connection to the network interface 1548 can also include, for exemplary purposes only, internal and external technologies such as, modems including regular telephone grade modems, cable modems and DSL modems, ISDN adapters, and Ethernet cards.

The present invention can be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix (s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

performing bang-anneal-bang quantum optimization

What is claimed is:

1. A computer-implemented process for performing bang-anneal-bang quantum optimization, the process comprising: identifying base curve v(t); setting a total runtime of the process; creating an initial guess for parameters in an ansatz; creating an initial guess for parameters in an ansatz; evolving a quantum state from a ground state of B following Hamiltonian H(t)=u(t) B+(1−u(t)) C and, at termination of evolving the quantum state, measuring the resulting quantum state; updating the parameters for the ansatz based on the resulting quantum state; repetitively creating the ansatz for u(t), evolving the quantum state from the ground state of B following Hamiltonian H(t), and, at termination of evolving the quantum state, determining the resulting quantum state until the classical outer loop converges to a selected convergence limit; and returning the final form of u(t) to perform bang-anneal-bang quantum optimization.

2. The process of claim 1, further comprising taking v(t) as a linear function such that v(t)=1−t/T0. Here, T0 is an amount of time under which a quantum computer on which the process is performed maintains coherence.

3. The process of claim 1, further comprising determining v(t) by performing a QAOA procedure at some desired depth p.

4. The process of claim 1, further comprising setting beta=beta_p and gamma=gamma_0 from the QAOA procedure.

5. The process of claim 1, further comprising making omega=2π/tau, wherein tau is the average time taken in each beta-gamma layer of QAOA.

6. The process of claim 1, further comprising parameterizing omega and A.

7. The process of claim 1, further comprising using T as a variational parameter.

8. The process of claim 1, further comprising updating and optimization by a classical optimization algorithm comprising a Nelder-Mead algorithm or gradient descent algorithm.

9. A method implemented by a system of one or more processors, the method comprising: identifying base curve v(t); setting a total runtime of the process; creating an initial guess for parameters in an ansatz; creating an initial guess for parameters in an ansatz; evolving a quantum state from a ground state of B following Hamiltonian H(t)=u(t) B+(1−u(t)) C and, at termination of evolving the quantum state, measuring the resulting quantum state; updating the parameters for the ansatz based on the resulting quantum state; repetitively creating the ansatz for u(t), evolving the quantum state from the ground state of B following Hamiltonian H(t), and, at termination of evolving the quantum state, determining the resulting quantum state until the classical outer loop converges to a selected convergence limit; and returning the final form of u(t) to perform bang-anneal-bang quantum optimization.

10. The process of claim 1, further comprising taking v(t) as a linear function such that v(t)=1−t/T0. Here, T0 is an amount of time under which a quantum computer on which the process is performed maintains coherence.

11. The process of claim 1, further comprising determining v(t) by performing a QAOA procedure at some desired depth p.

12. The process of claim 1, further comprising setting beta=beta_p and gamma=gamma_0 from the QAOA procedure.

13. The process of claim 1, further comprising making omega=2π/tau, wherein tau is the average time taken in each beta-gamma layer of QAOA.

14. The process of claim 1, further comprising parameterizing omega and A.

15. The process of claim 1, further comprising using T as a variational parameter.

16. The process of claim 1, further comprising updating and optimization by a classical optimization algorithm comprising a Nelder-Mead algorithm or gradient descent algorithm.

17. Non-transitory computer storage media storing instructions for execution by a system of one or more processors, the system being included with instructions causing the one or more processors to perform operations comprising: identifying base curve v(t); setting a total runtime of the process; creating an initial guess for parameters in an ansatz; creating an initial guess for parameters in an ansatz; evolving a quantum state from a ground state of B following Hamiltonian H(t)=u(t) B+(1−u(t)) C and, at termination of evolving the quantum state, measuring the resulting quantum state; updating the parameters for the ansatz based on the resulting quantum state; repetitively creating the ansatz for u(t), evolving the quantum state from the ground state of B following Hamiltonian H(t), and, at termination of evolving the quantum state, determining the resulting quantum state until the classical outer loop converges to a selected convergence limit; and returning the final form of u(t) to perform bang-anneal-bang quantum optimization.

18. The process of claim 1, further comprising taking v(t) as a linear function such that v(t)=1−t/T0. Here, T0 is an amount of time under which a quantum computer on which the process is performed maintains coherence.

19. The process of claim 1, further comprising determining v(t) by performing a QAOA procedure at some desired depth p.

20. The process of claim 1, further comprising setting beta=beta_p and gamma=gamma_0 from the QAOA procedure.

21. The process of claim 1, further comprising making omega=2π/tau, wherein tau is the average time taken in each beta-gamma layer of QAOA.

22. The process of claim 1, further comprising parameterizing omega and A.

23. The process of claim 1, further comprising using T as a variational parameter.

24. The process of claim 1, further comprising updating and optimization by a classical optimization algorithm comprising a Nelder-Mead algorithm or gradient descent algorithm.
